(19) United States
(12) Patent Application Publication
(10) Pub. No.: US 2018/0082545 A1
(43) Pub. Date: Mar. 22, 2018

(54) COMPETITIVE, SKILL-BASED GAMING WITH WAGERS BY ACTIVE PARTICIPANTS AND SIDE BETTING

(71) Applicant: Competition Interactive LLC, Las Vegas, NV (US)

(72) Inventors: Keith Winters, Las Vegas, NV (US); Matthew Mahaney, Henderson, NV (US); Paul Steelman, Las Vegas, NV (US)

(21) Appl. No.: 15/713,438

(22) Filed: Sep. 22, 2017

Related U.S. Application Data
(60) Provisional application No. 62/398,507, filed on Sep. 22, 2016.

(51) Int. Cl. G07F 17/32

(52) U.S. Cl. CPC G07F 17/3295; G07F 17/3272; G07F 17/3211; G07F 17/3288; G07F 17/3244; G07F 17/3267

(57) ABSTRACT

A gaming method enables active participation in a physically competitive skill-based game, as well as passive participation in the physically competitive skill-based game. One or more players, or active participants, in the game may participate in and may wager on the outcome of the physically competitive skill-based game, while one or more other individuals, or passive participants, who do not actively participate in the physically competitive skill-based game may also wager on an outcome of the game (i.e., the same game).

### CROSS-REFERENCE TO RELATED APPLICATION

A claim for the benefit of the Sep. 22, 2016 filing date of U.S. Provisional Patent Application No. 62/398,507, titled COMPETITIVE, SKILL-BASED GAMING WITH WAGERS BY ACTIVE PARTICIPANTS AND BACK-BETTING BY PASSIVE PARTICIPANTS (“the '507 Provisional Application”) is hereby made pursuant to 35 U.S.C. § 119(e). The entire disclosure of the '507 Provisional Application is hereby incorporated herein.

### TECHNICAL FIELD

This disclosure relates generally to gaming methods and, more specifically, to gaming methods that provide both active participants and passive participants with the ability to place wagers. Even more specifically, this disclosure relates to gaming methods that enable one or more players, or active participants, to wager on the outcome of a competitive skill-based game in which they actively participate, while enabling one or more other individuals, who do not actively participate in the game, to also wager on an outcome of the game (i.e., the same game). The competitive skill based game may be a game of physical skill.

### SUMMARY

A gaming method according to this disclosure includes a competitive, skill-based game in which players, who are also referred herein to as “active participants,” may place wagers and play the competitive, skill-based game while other individuals, who are also referred to herein as “passive participants,” as “observers,” or as “side bettors,” may place wagers on one or more outcomes of the competitive, skill-based game. For the sake of simplicity, the term “game” may be used herein to refer to a competitive, skill-based game. The wagers may be placed and the game played at the same location, which is referred to herein as a “central location.” In some embodiments, the competitive, skill-based game may comprise a game of physical skill, such as a racing game (e.g., a motorsport game, a horse racing game, a foot race game, etc.), a so-called “shooter” game, a dance competition, or the like.

In some embodiments, game play at the central location may include game play at a plurality of gaming stations that are grouped together. Side betting, or proposition betting, at the central location may include placing side bets at one or more wagering stations grouped with the gaming stations.

Each active participant in a game may select a character that will represent the active participant as he or she plays the game. In addition, each active participant may provide personal information, such as a skill level based on the active participant's prior experiences with the game. Wagering on a game may commence when a wager on an outcome of the game is first placed by and received from an active participant at a gaming station (a wager may be received from an active participant at one or more of the gaming stations).

The game may receive wagers for a predetermined period of time. Again, the predetermined period of time may begin once an active participant decides to initiate a new round of game play by placing a wager. During that predetermined period of time, additional active participants may elect to participate in the game and one or more passive participants and, optionally, one or more active participants may place wagers, or side bet, on one or more events, including, without limitation, the results achieved by active participants in the game. In some embodiments, the predetermined period of time may be extended by an additional period of time each time an additional wager is placed on the new round of game play.

If any positions in the game (e.g., gaming stations at the central location, etc.) remain unoccupied when the opportunity for active participants to join a game has elapsed, the game may provide a computer-controlled active participant, or a computer-controlled character, for participation at each of those positions. If, in the alternative, all of the available positions within the game (e.g., all of the gaming stations at the central location, etc.) are occupied by live active participants in the game, game play may occur only between the live active participants; i.e., without any computer-controlled characters. Optionally, the game may provide one or more computer-controlled characters regardless of whether all of the positions in the game are occupied by live active participants; thus, the number of active participants in the game, including live active participants, and computer-controlled characters, may exceed the number of positions available at the central location for live active participants. A skill level may be assigned to each computer-controlled character.

One or more wagers, or side bets, on the outcome of the same game may then be placed and received from one or more passive participants at each wagering station and, optionally, from one or more active participants at wagering devices of the gaming stations they occupy. Passive participants and any active participants who choose to place side bets, may place wagers on live individuals who are actively participating in the game, who may be referred to as “live active participants,” or on virtual participants, or computer-generated, computer-controlled active participants or computer-controlled characters, in the game.

Once the designated period of time for placing wagers is complete, a new round of game play may be initiated by the game. During game play, the game may provide outputs and receive inputs from each active participant. Game inputs may be received from an active participant through input devices, or “control devices,” at a gaming station occupied by the active participant. The control devices and, thus, the inputs received therethrough, correspond to the type of game being played.

As the game is played, or executed, the inputs received by the game may be used to dynamically determine and/or adjust each live active participant's skill level. The inputs received by the game may also affect the outputs provided by the game. As an example of the outputs provided by the game, progress of the game may be displayed. The progress of the game may be displayed to each live active participant from his or her perspective. As an example, a monitor, or a display, of a gaming station may provide each live active participant with a view of the game as if he or she were actually present in a virtual environment in which the game occurs. In addition to displaying the virtual environment to each live active participant, the game may output additional data that corresponds to the type of game being played. For example in a race-type game, the active participant's speed may be displayed, as may additional information pertinent to the particular type of game (e.g., RPMs of an engine, gearing, gravitational forces through a curve, etc., in a ground race on a vehicle; heart rate, respiratory rate, etc., in foot race; a measure of fatigue, etc., while riding an animal; etc.).

Progress of the game may also be displayed to each live passive participant, as well as to other onlookers who may or may not be invested in or have a stake in the outcome of the game.

During game play, in addition to providing each active participant with an individualized visual perspective of the game, the game may provide each live active participant with other types of sensory feedback. The sensory feedback the game provides to each live active participant may correspond to that active participant's location in the virtual environment within which game play occurs, and may more specifically correspond to events in the game in which the live active participant is involved, as well as to events occurring in proximity to the location of the live active participant within the virtual environment. The sensory feedback that is provided to each live active participant may include an audible experience. The game may also provide each live active participant with a tactile experience (e.g., haptic feedback in input devices, seat vibration corresponding to events in the game in which the active participant is involved, etc.). Other types of sensory feedback may also be provided by a game according to this disclosure.

Display of the progress of the game to individuals who are not actively participating in the game may be provided from the vantage point of a spectator, who may have a wider view of the virtual environment in which the game occurs than the view displayed to any active participant in the game. In some embodiments, the entire virtual environment for the game may be displayed to any spectators, including passive participants, other onlookers, and passersby. Such a wide display may be provided by way of a public display monitor associated with the gaming units and the wagering station(s) at the central location. The game may also provide corresponding audio outputs at the location where the game is widely displayed and the gaming stations and wager station(s) are grouped together. These wide area audio outputs provided by the game may correspond to the types of sounds that spectators would hear (optionally based on the position(s) of the spectators) while watching the type of event depicted by the game.

In addition to providing onlookers and passersby with a wide view and a wide area audio output of the virtual environment in which the game is being played, publicly displaying the game to onlookers and passersby may attract the interest of potential participants, including potential active participants, potential passive participants, or both, in the game.

Once game play is complete, an award, if any, available to each live active participant and to each passive participant may be determined and paid out. In addition to basing awards on results achieved by the live active participants, a live active participant's skill level may at least partially determine the value of one or more of that live active participant's awards (e.g., a random award, a bonus award, and/or a merit-based award, etc.). Payouts may be made in any manner known in the art. Without limitation, an account held by the participant may be credited with the payout or a cash payout may be made.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 illustrates an embodiment of a central location where a plurality of gaming stations and a plurality of wagering stations may be arranged and located, along with any public displays and any public audio systems;

FIG. 2 is a flow chart of an embodiment of a manner in which individuals may actively and passively participate in a game of physical skill in accordance with this disclosure;

FIG. 3 includes a series of images that depict an embodiment of the flow of the process by which an individually may passively participate in a game of physical skill by placing a side bet on the game; and

FIGS. 4-13 show different images that may be displayed to a passive participant who has side bet on a game of physical skill as active participants initiate their participation in the game, the passive participant places his or her wager, game play occurs, the game is complete, and any awards are granted.

### DETAILED DESCRIPTION

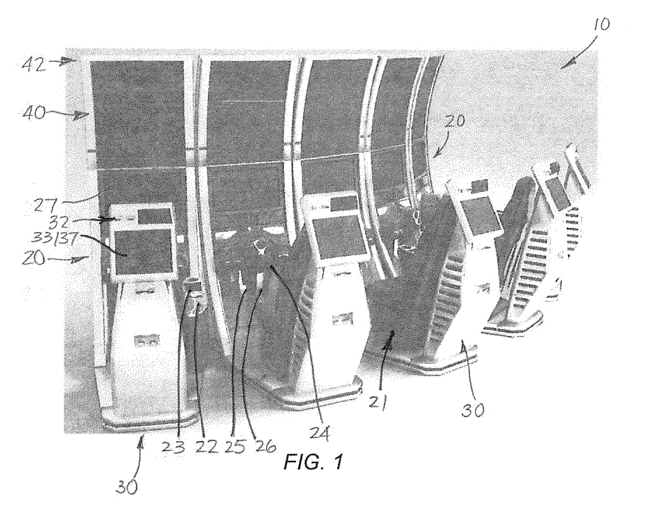

With reference to FIG. 1, a game according to this disclosure may be played at a gaming station 20. In some embodiments, the gaming station 20 may be grouped with one or more other gaming stations 20 at a central location 10 (e.g., at the depicted bank of gaming stations 20, etc.). Each gaming station 20 may include features that enable an active participant in the game to place a wager, initiate game play, and participate in game play. In the depicted embodiment, in which the game is a racing game, each gaming station 20 resembles an automobile cockpit with features with which an active participant in the game may interact. These features may include, but are not limited to, a seat 21, one or more wager inputs 22 (e.g., coin and/or bill acceptors, card readers, touch pads for receiving financial account information, etc.), a wager selection device 23 (e.g., a touch-sensitive input/display screen, etc.), a plurality of game inputs (e.g., a steering wheel 24, an accelerator pedal 25, a brake pedal 26, etc.), a display 27, and one or more audio outputs 28.

A wagering station 30 may be associated with one or more gaming stations 20. In embodiments where a plurality of gaming stations 20 are grouped at a central location 10, each wagering station 30 may also be located at the central location 10. Each wagering station 30 may include features that enable a passive participant in the game to place one or more bets, each of which is referred to herein as “side bet,” on the game. In the illustrated embodiment, each wagering station 30 is physically associated with a corresponding gaming station 20, and may comprise part of the same gaming unit as the corresponding gaming station. More specifically, each wagering station 30 may be positioned directly behind a location of the gaming station 20 that is to be occupied by a live active participant (e.g., the depicted seat 21, etc.) or even incorporated into that location of the gaming station (e.g., into a back of the seat 21, etc.). Thus, each passive participant may place a wager in proximity to or at the same location (e.g., on the same gaming unit, etc.) as an active participant will play the game. In some embodiments, a passive participant may occupy that location throughout the course of the game. Accordingly, although a passive participant does not actively participate in the game, each passive participant may occupy a position in the central location 10 while placing wagers and while the game is being played, enabling that passive participant to experience the game's action from a location close to or even in the middle of that action.

As illustrated, each wagering station 30 may include one or more wager inputs 32 (e.g., coin and/or bill acceptors, card readers, touch pads for receiving financial account information, etc.) and a wager selection device 33 (e.g., at least a portion of touch-sensitive input/display 37, etc.).

In some embodiments, a public display monitor 40 may be associated with a gaming station 20 and its corresponding wagering station 30. A public audio system 42, which may include one or more loudspeakers, may be associated with the public display monitor 40. In embodiments where two or more gaming stations 20 are grouped together at a central location 10, the public display monitor 40 and public audio system 42, if any, may also be situated at the central location 10. The public display monitor 40 and public audio system 42 may enable passive participants and other observers to view and hear the game from a spectator's perspective. Thus, the public display monitor 40 and public audio system 42 may entertain observers and passersby and attract the attention of potential participants (active and passive) in the game.

Further disclosure of each gaming station 20, each wagering station 30, the central location 10, and the public display monitor 40 are provided by U.S. patent application Ser. No. 15/667,608, filed on Aug. 2, 2017, and titled GAMING CONSOLE FOR SIMULTANEOUSLY ENABLING ACTIVE AND PASSIVE PARTICIPATION, the entire disclosure of which is hereby incorporated herein.

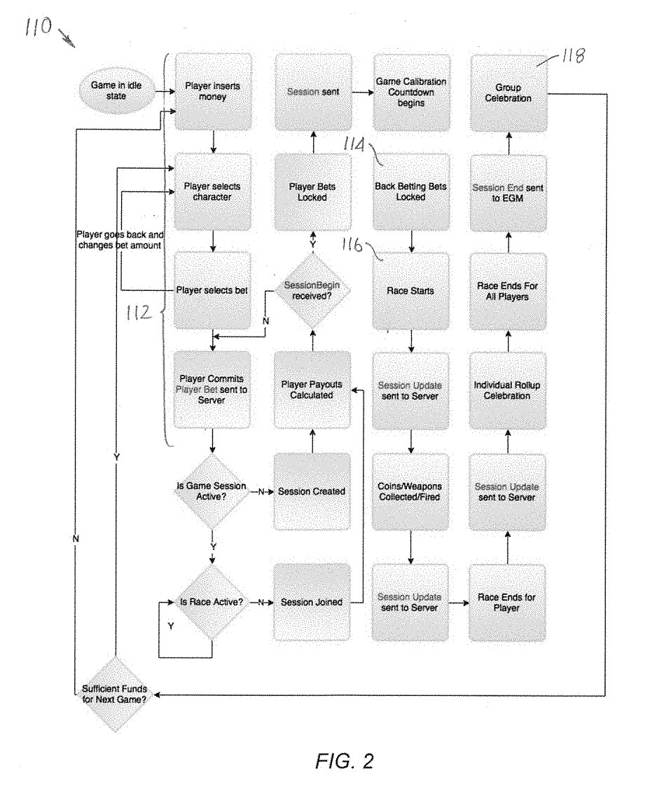

The flow chart of FIG. 2 illustrates an embodiment of game play 110 in accordance with this disclosure.

At reference 112, an individual who wants to actively participate in the game (i.e., be an active participant in the game) may interact with a gaming system. For example, the individual may occupy a gaming station 20 (FIG. 1) (e.g., take a seat 21 at the gaming station 20, stand at the gaming station 20, etc., depending upon the type of game and the features of the gaming station 20). The individual may provide the game with identifying information, which may include information about the individual's history in playing the game (e.g., points-based criteria based on previous results, an indicator of the individual's skill level, a history of the individual's winnings from playing the game, etc.). The individual may select a character that will represent the individual as he or she plays the game. In addition, the individual may enter a wager at the gaming station 20. Each active participant may wager that he or she will win, place, or show in the game and, optionally, that he or she will achieve certain objectives while playing the game. Once the individual has selected a character and placed a wager, game play may begin.

In some embodiments, a countdown timer may begin once the individual places his or her wager. The countdown timer may be visibly displayed by any gaming stations 20, wagering stations 30 and, optionally, public display monitors 40 associated with the gaming station 20 occupied by the individual. Thus, game play may begin after the active participant places his or her wager (e.g., within a predetermined duration of time after the active participant places his or her wager, within a predetermined window of time (i.e., by a set time), etc.).

Other individuals who want to actively participate in the game may occupy other associated gaming stations 20, optionally provide identifying information, and select any other available characters. In a specific, but nonlimiting example, once a first individual places a wager on a race, other individuals who wish to actively participate in the race may have ten (10) seconds to select their respective characters and place their wagers on whether or not they will win the race.

One or more computer-controlled characters may also be randomly selected for participation in the game. A skill level (e.g., beginner, intermediate, advanced; one star to five stars; etc.) may be assigned to computer-controlled character. The assigned skill level for each computer-controlled character may be randomly generated, assigned on the basis of known skill levels of live active participants in the game, or assigned randomly in a range based on the known skill levels of live active participants against whom the computer-controlled characters will compete. The skill level assigned to each computer-controlled character may remain the same throughout a game.

At reference 114 of FIG. 2, once game play between two or more active participants (e.g., two or more individuals, combinations of one or more individuals and one or more computer-controlled characters, etc.) has been initiated, a side betting period may begin. The side betting period may have any suitable duration. In a specific, but nonlimiting embodiment, the side betting period may have a duration of thirty (30) seconds.

Each side bets may have a fixed amount (e.g., $1, $5, $10, etc.). Alternatively, the amount of each side bet may be determined by the side bettor.

During the side betting period, individuals who want to bet on the game, including individuals who do not want to actively participate in the game (i.e., individuals who wish to be passive participants) and, optionally, active participants, may interact with the gaming system to place wagers, or side bets, on one or more possible outcomes of the game. A passive participant may interact with the gaming system at a wagering station 30, which may enable him or her to place a wager, or a side bet, on the outcome of the game that has been initiated. In addition to actively participating in the game, an active participant may, in some embodiments, place a side bet or multiple side bets on the outcome of the game by interacting with a wagering device of the gaming station the active participant occupies. Thus, while the ensuing disclosure refers to the placement of side bets by a passive participant through a wagering station 30, it should be recognized that the ensuing disclosure may also refer to the placement of side bets by an active participant through the wagering device of the gaming station 20 the active participant occupies. Therefore, as used hereinafter, the phrase “passive participant” may, in such embodiments, also refer to active participants and the phrase “wagering station 30” may, in such embodiments, also refer to the wagering device of a gaming station 20.

Each passive participant may place wagers on one or more events that may occur as the game is played and/or at the conclusion of the game. Without limitation, each passive participant may place wagers on one or more of the following items: which environment (e.g., race track, etc.) will be randomly selected from a predetermined group of environments in which the game may occur; which item, or gem, (e.g., power enhancement, defense, repair, weapon, hazard, etc.) will be collected by an active participant first; which type of character (e.g., female, male, animal, etc.) will win the game, which may provide odds based on the ratio of each type of character out of all of the characters representing active participants in the game (e.g., 4:9 female, 3:9 male, and 2:9 animal in an embodiment of a game in which 4 females, 3 males, and 2 animals compete, etc.); and/or a specific outcome of the game (e.g., win, place, show, top two finishers, exacta, trifecta, etc.). In some embodiments, a side better could place a wager on which item, or gem, will be used first in a game, which active participant will leave the track or wreck first, or any of a variety of possible outcomes during game play.

In placing a wager on a specific out of the game, a passive participant may place a wager on an active participant, or character, the passive participant hopes, thinks, or bets will win the game (i.e., finish first in the game). As another example, the passive participant may place a wager on an active participant the passive participant hopes, thinks, or bets will win the game, place in the game (i.e., finish first or second in the game), or show in the game (i.e., finish first, second, or third in the game). Other possible side bets include wagers on a so-called “exacta,” or “two-racer pick,” in which the passive participant selects one active participant to finish first and another active participant to finish second, and a so-called “trifecta,” or “three-racer pick,” in which the passive participant wagers that a first active participant will finish first in the game, a second active participant will finish second in the game, and a third active participant will finish third in the game. Side bets may, in some embodiments, be placed on one or one or more events in the game (e.g., objectives achieved by one or more active participants in the game, etc.). The wagering station 30 may display and enable the passive participant to select from characters that have been selected by one or more individuals and/or computer-controlled characters.

In embodiments of the game where one or more mystery prizes or cash drops are available to active participants, a pool for each possible mystery prize or bonus may be set to a start value. The start value for each bonus prize pool may be zero or a predetermined base amount (e.g., a minimum wager amount, a multiplier of a minimum wager amount, etc.) if a mystery prize or bonus was awarded during the previous game. In some embodiments, the pool for each possible mystery prize or bonus may be semi-progressive or progressive; if no mystery prize or bonus was awarded during the previous game, the start value for each mystery prize or bonus may be greater than zero or greater than the predetermined base amount or the start value for each mystery prize or bonus may be equal to the value of the mystery prize or bonus at the end of the previous game.

In some embodiments, the total amount of the side bets placed on the results of a game may determine the amount(s) of one or more awards that are available to active participants in the game. Without limitation, the amount of a possible award pool for a mystery prize or bonus which may also be referred to as a “bonus prize pool,” available to an active participant in the game (e.g., a treasure chest captured by an active participant, etc.) may be based on the total amount of the side bets placed on the outcome of the game, the total amount of the side bets placed on a certain outcome in the game (e.g., which active participant will receive the mystery prize or bonus, etc.), and/or the amount wagered that the active participant who actually receives the mystery prize or bonus would receive the mystery prize or bonus. A percentage of the side bets placed by passive participants (e.g., a percentage of the total amount of the side bets that have been placed, a percentage of the amount of the side bets that was dedicated to the bonus prize pool, a percentage of the amount of the side bets that was dedicated to a particular recipient of the bonus prize pool, etc.) may be contributed to the bonus prize pool. The amount that is actually awarded to an active participant for receiving a mystery prize or bonus may be akin to the betting experience utilized on a typical slot machine. It is possible that no active participant in a game will win a mystery prize or bonus or, thus, any portion of the bonus prize pool for that game.

At reference 116 of FIG. 2, once all active participants and/or passive participants who will participate in a game have placed wagers on the game, game play may begin. In embodiments where a countdown timer is used, this may happen when the countdown is complete or within a predetermined duration of time, or a grace period for finalizing wagers, after the countdown is complete. When game play begins, further side betting may be locked out. Alternatively, in-game side betting may be enabled.

Each active participant may play the game (provide inputs, perceive outputs) at a gaming station 20 (FIG. 1). The results achieved by each active participant during game play may be based, at least in part, upon that active participant's skill in playing the game. Each active participant's skill may be determined and adjusted as he or she plays the game. As an example, a “skill-o-meter” may rate each active participant's skill level on a scale (e.g., beginner, intermediate, advanced; one star to five stars; etc.). At the start of a game, an active participant's skill level may be set at a baseline (e.g., zero, one star, two stars, three stars, etc.). In some embodiments, the active participant's skill level may be set at the baseline each time he or she starts a new game. In other embodiments, an active participant's skill level at a particular game may be portable; the active participant's skill level may be input into the game, and his or her initial skill level during a game may be the same as his or her skill level at the completion of the game in which he or she most recently participated.

In a racing game, the active participant's skill level may be rated based on any of a variety of factors, or any combination of a variety of factors. One example of such a factor may be the active participant's skills in navigating the race course (e.g., lines travelled along the race course by the active participant's character, not taking sweeping bends too wide, not bumping into walls, obstacles, other racers' vehicles, etc.; use and location(s) of acceleration, braking, gear shifting, drift functions, etc.; etc.), which may be referred to as the active participant's “navigation” skills. Another example of such factor may be the active participant's ability to avoid other racer's deployed items, or hazards or gems, and/or his or her ability to avoid walls while drifting, which may be referred to as the active participant's “avoidance” skills. As yet another example of such a factor, an active participant's skill at using or deploying his or her own tools or other items (e.g., hazards, gems, etc.) to his or her best advantage (e.g., hitting another vehicle with a missile (or not), cracking an egg in the path of another racer's vehicle (or not), etc.) may be rated, as may the speed with and circumstances under which such items are used; these may be referred to as “deployment” skills. The skill level of that active participant may be adjusted dynamically as the active participant plays the game.

An active participant's skill level may qualify him or her for mystery prizes or bonuses. The higher an active participant's skill level, the more chances he or she may have to receive bonuses. In addition, the value of any award the active participant receives for his or her performance during the game (e.g., final placement in a race, total points earned, etc.) and, optionally, the value(s) of an active participant's mystery prizes (e.g., prizes that may be made available to an active participant during game play, etc.) and/or bonuses (e.g., a bonus reel at the end of the game, etc.) may be determined based on a measure of the active participant's skill while playing the game (e.g., his or her average skill level during the game, his or her skill level at the conclusion of the game, etc.). In other embodiments, the value of each award to an active participant may be based on measures of the skill of active participant's competitors while playing the game or on a combination of the active participant's skill level and his or her competitors' skill levels. Thus, in embodiments where an active participant's skill level increases as he or she gains more experience playing a particular game (e.g., a race game, etc.), the values of the awards that are available to the active participant may also increase the more he or she plays the game.

Each passive participant may view the game on a public display monitor 40 (FIG. 1) and, optionally, hear the game from a public audio system 42 (FIG. 1). In some embodiments, one or more passive participants may place in-game wagers at reference 114 of FIG. 1.

Once certain events have occurred during game play and/or after game play is complete, at reference 118 of FIG. 2, an award for each active participant and each passive participant may be determined. A determination may be made as to whether or not a participant will receive an award by comparing a wager made by the participant to a corresponding actual result (e.g., of the game, of an event during the game, etc.). If the participant wagered on a particular outcome that actually occurred, the amount of the wager may then be determined (e.g., as a set multiplier of the amount wagered, based on odds (as determined, e.g., by PAR (probability account reporting) sheets, racetrack betting odds (see, e.g., http://wizardofodds.com/games/racetrack-betting/, http://arlingtonpark.com/racing-wagering/Betting101, etc.), based on a payout table, etc.).

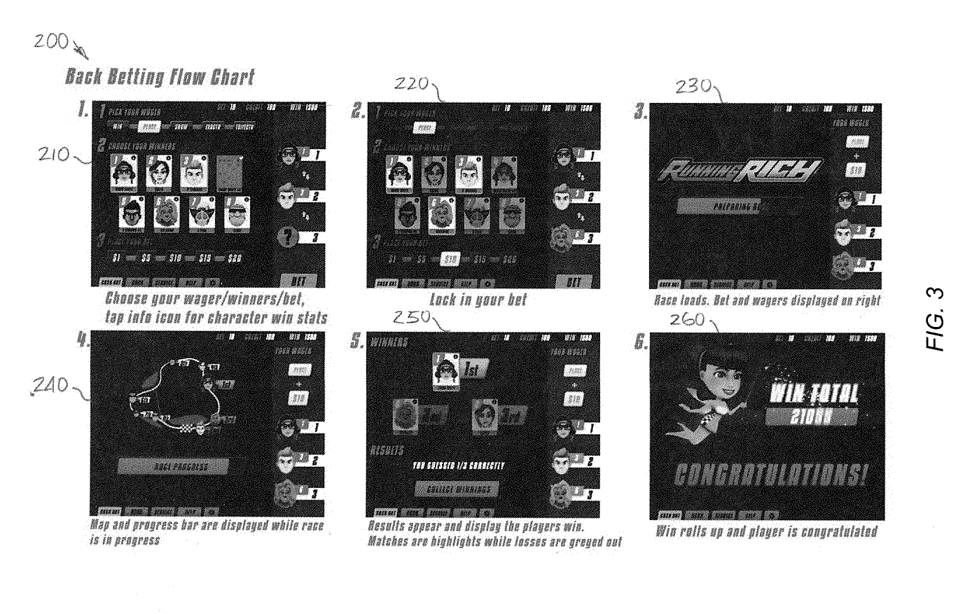

FIGS. 3-13 illustrate a specific, but non-limiting, embodiment of the manner in which a passive participant may place wagers on the specific outcome (e.g., which active participant(s) win(s), place(s), or show(s), etc.) of an embodiment of a game according to this disclosure.

In FIG. 3, the basic flow of an embodiment of side betting process 200 is depicted. At reference 210, a passive participant may, at a wagering station 30 (FIG. 1), select a type of wager to be placed, select each active participant, or character, on which a wager is to be placed, and select an amount of each wager. The passive participant may lock in his or her wager at reference 220. Once the passive participant has locked in his or her wager and the game loads, specific information about the wager may be shown on part of the display 37 (FIG. 1) of the wagering station 30, as shown at reference 230 of FIG. 3. While the game is in progress, the status of the game may also be shown in real-time on the display 37 of the wagering station 30, as represented by reference 240. At the conclusion of the game, the results of the game may be shown on the display 37, as depicted at reference 250, and the results of the wager may also be shown on the display, as depicted at reference 260.

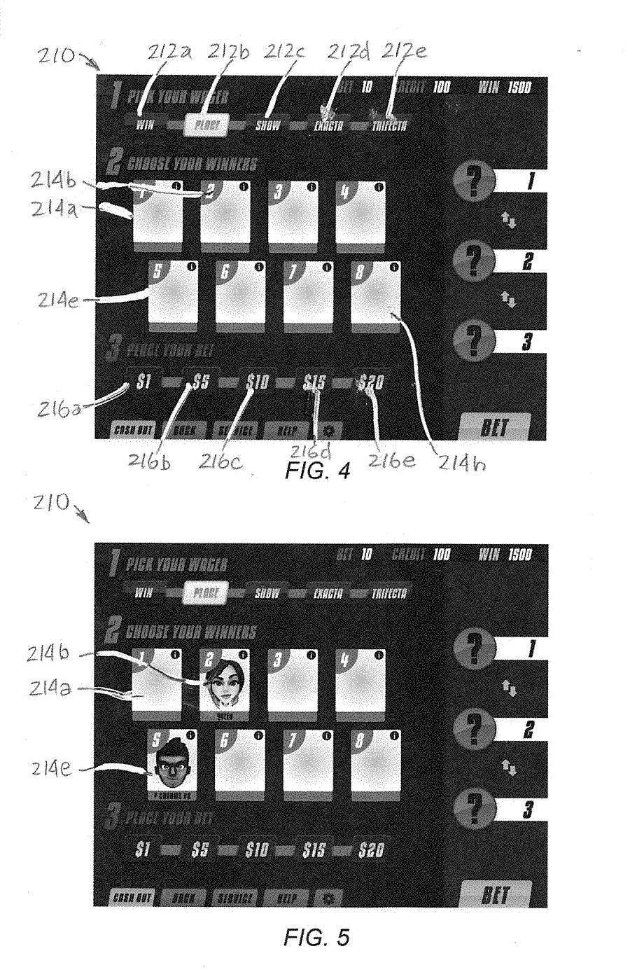

FIG. 4 shows an embodiment of an image 210 that may be shown on a display 37 (FIG. 1) of a wagering station 30 (FIG. 1) at the beginning of a new game. Such an image 210 may be referred to as a “default state” image. At this point in time, no active participants have entered the game and no passive participants have placed side bets on the outcome of the game.

At the start of a new game, the image 210 shows that no location for the identity of an active participant (i.e., card 214a, 214b, etc.) has been populated, no wager (i.e., button 212a, 212b, etc.) has been selected, and no wager amount, or “bet,” (i.e., button 216a, 216b, etc.) has been selected.

The cards 214a, 214b, etc., of the image 210 shown by the display 37 (FIG. 1) of the wagering station 30 may correspond to the maximum number of active participants in the game. At least some of the cards 214a, 214b, etc., may correspond to gaming stations 20 (FIG. 1) at the same central location 10 (FIG. 1) as the wagering station 30 (FIG. 1) on which the image 210 of FIG. 4 is displayed. In some embodiments, the number of cards 214a, 214b, etc., of the displayed image (e.g., the eight cards 214a-214h depicted in FIG. 4) may exceed the number of gaming stations 20 available at the central location 10. In the illustrated embodiment, the central location 10 may include five (5) gaming stations 20. Thus, five (5) of the cards 214a-214e may correspond to gaming stations 20 at the central location 10. The cards 214f, 214g, etc., that do not correspond to gaming stations 20 (e.g., the remaining three cards 214f, 214g, and 214h) may be reserved for computer-controlled characters.

Before side betting and game play may begin, a plurality of the cards 214a, 214b, etc., of the image 210 shown by the display 37 (FIG. 1) of the wagering station 30 (FIG. 1) must be populated one or more active participants in a game. As illustrated by FIG. 5, as active participants occupy gaming stations 20 (FIG. 1), select characters that will represent them in the game, and place wagers, the character selected by each active participant will populate a card 214a, 214b, etc., that corresponds to the gaming station 20 occupied by the actual participant. More specifically, in FIG. 5, cards 214b and 214e have been populated with characters that have been selected by the active participants who occupy the gaming stations 20 located at positions 2 and 5 of the central location 10.

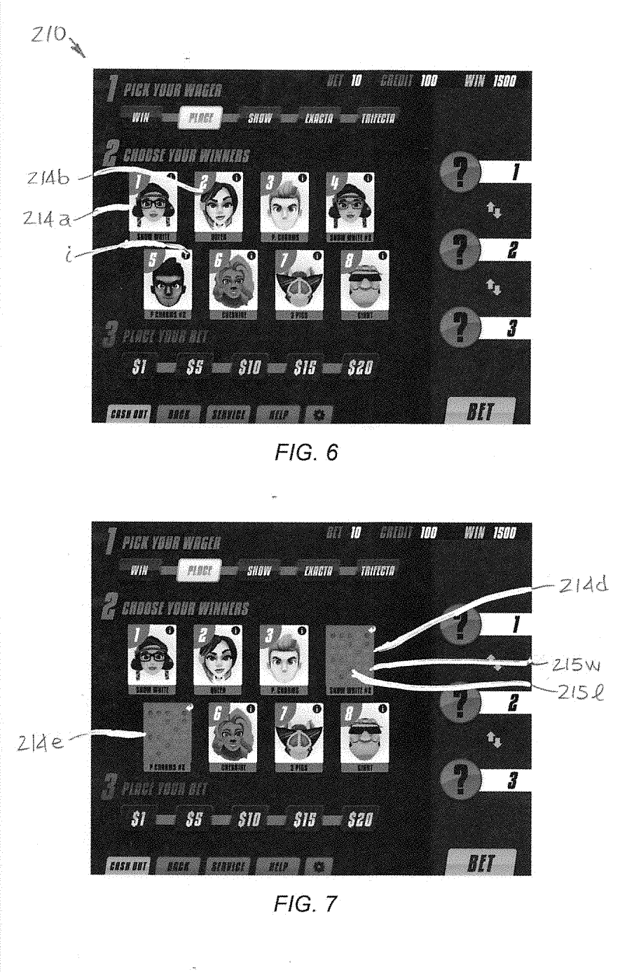

At a predetermined time (e.g., a scheduled start time, at the end of a countdown for active participants to join the game (e.g., ten (10) seconds, etc.), etc.), the game may populate each card 214a, 214b, etc., that corresponds to a gaming station 20 (FIG. 1) at the central location 10 (FIG. 1) that is not occupied by a live active participant with a computer-controlled character. Thus, a game may be played with one or more computer-controlled active participants. In some embodiments, all of the active participants in the game may be computer-controlled. In the image 210 shown in FIG. 6, each of the cards 214a, 214b, etc., has been populated with a character that corresponds to a live active participant or a computer-controlled active participant.

Each card 214b, 214e, etc., that has been populated may be activated. When a card 214a, 214b, etc., is activated, or active, a passive participant may select an information link i on that card 214a, 214b, etc. (e.g., by touching the display 37 at the location where the card 214a, 214b, etc., appears), to view information associated with the character and/or the active participant with whom the character is associated. Such information may include a history of the character's and/or active participant's past performance in the game, game placement trend data for the character and/or the active participant, and the like. FIG. 7 illustrates a specific embodiment of the way in which information associated with a character's and/or an active participant's past performance may be communicated to a passive participant in the game. As illustrated, when the passive participant selects the information link i on a particular card 214d, 214e, that card 214d, 214e flips to its back side to depict information about previous results achieved by the corresponding character and/or active participant while playing the game. More specifically, FIG. 7 depicts an embodiment in which the information is presented as a five (5) by six (6) array of dots 215 (thirty (30) dots total) that show whether the character and/or active participant won (illustrated by a green dot 215w) or lost (illustrated by a red dot 215l) up to thirty (30) previous games. Each card 214d, 214e may be flipped back over to its front side by selecting an icon on that card 214d, 214e, such as the curved arrow depicted at the top right corner of each flipped card 214d, 214e.

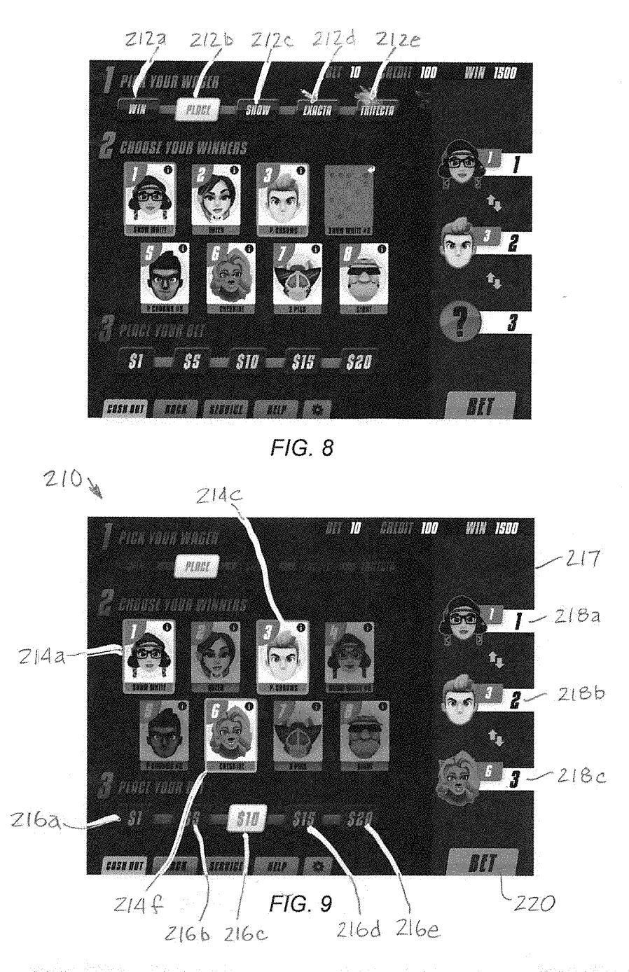

Turning now to FIG. 8, a passive participant may place a wager by selecting a type of wager to be placed. In the depicted embodiment, the passive participant may select a button 212a, 212b, etc., from a plurality of buttons 212a, 212b, etc., that corresponds to the type of wager the passive participant wants to place (e.g., by touching the display 37 at the location where the button 212a, 212b, etc., that corresponds to the passive participant's selection appears). More specifically, FIG. 8 depicts an embodiment in which a passive participant may wager: that an active participant, or character, will win the game (i.e., place first) by selecting button 212a; that an active participant will place in the game (i.e., place first or second) by selecting button 212b; that an active participant will show in the game (i.e., place first, second, or third) by selecting button 212c; on an exacta (i.e., that a particular active participant will place first and that another particular active participant will place second) by selecting button 212d; or on a particular trifecta (i.e., that a particular active participant will place first, that another particular participant will place second, and that a third particular participant will place third) by selecting button 212e. In some embodiments of the game, a passive participant may select a single active participant for a win, place, or show wager. In other embodiments, the passive participant may select two or more active participants (e.g., first and second choices; first, second, and third choices; etc.) for each win, place, or show wager. In the specific example illustrated by FIG. 8, the passive participant has decided to make a “place” wager.

Once the passive participant has identified the type of wager he or she would like to make, the passive participant may select one or more active participants on which he or she is wagering. As illustrated by FIG. 9, each active participant, or character, may be selected by selecting a corresponding card 214a, 214b, etc., dragging a representation of the character on that card to a desired place position 218a (first place), 218b (second place), or 218c (third place) on the image 210 shown on the display 37 (FIG. 1) of the wagering station 30 (FIG. 1), and dropping the representation of the character at the desired placed position 218a, 218b, 218c. The place positions may be located at an edge 217 (e.g., on the right side of, etc.) the image 210. In the depicted embodiment, a passive participant has placed the representation of Snow White, the character on card 214a, in the first place position 218a, the representation of P. Charms, the character on card 214c, in the second place position 218b, and the representation of Cheshire, the character on card 214f, in the third place position 218c. When a passive participant places a single-character wager (e.g., a win, place, or show wager, etc.), that wager may be based on the character he or she places in the first place position 218a.

In some embodiments, the passive participant may be provided with an opportunity to make multiple win, place, or show wagers or to split a win wager, a place wager, or a show wager between two, three, or more characters who have been placed in place positions 218a, 218b, 218c. In embodiments where a wager may be split, the split may be equal or the manner in which the wager is split may be determined by the passive participant.

In other embodiments, the amount of the wager placed by the passive participant may be automatically split based on the type of wager placed and the number of characters that have been placed in the place positions 218a, 218b, 218c. For example, if the passive participant places a win wager, he or she will only receive an award if the character whose representation he or she has placed in the first place position 218a wins the game, regardless of whether or not the passive participant has placed any characters in place positions 218b and/or 218c. As another example, where, as in the depicted embodiment, the passive participant has made a “place” wager and has placed representations of characters in each of the place positions 218a, 218b, and 218c, the passive participant's wager may be split between the two characters that have been selected to place (i.e., between the characters that have been placed in the first place position 218a and the second place position 218b), and he or she may receive a first award if one of those characters places in the game and a greater, second award if both of those characters place in the game. Similarly, if the passive participant had placed a show wager and placed any of the three characters who showed in the game in any of the three place positions 218a, 218b, 218c, the passive participant may receive a separate award for each selected character that places in the game.

Before the passive participant's wager is finalized, he or she may make changes to the placement of one or more characters at a place position 218a, 218b, 218c by selecting a character whose representation is to be moved, dragging that character's representation to the desired location, and releasing that character's representation at the desired location. Without limitation, a passive participant may remove a representation of a character from a place position 218a, 218b, 218c; place a representation of another character at an unoccupied place position; and/or move a representation of a character from one place position 218a, 218b, 218c, to another place position 218a, 218b, 218c.

In addition to selecting the type of wager to be placed and one or more active participants, or characters, upon which the wager is to be placed, the passive participant may select an amount he or she would like to wager. In the embodiment depicted by FIG. 9, the passive participant may select a button 216a, 216b, etc., that shows the amount of the wager he or she would like to place. In other embodiments, the passive participant may select the amount of wager from a pre-populated menu (e.g., a pulldown menu, etc.), by entering the amount to be wagered into a keypad, or in any other suitable manner.

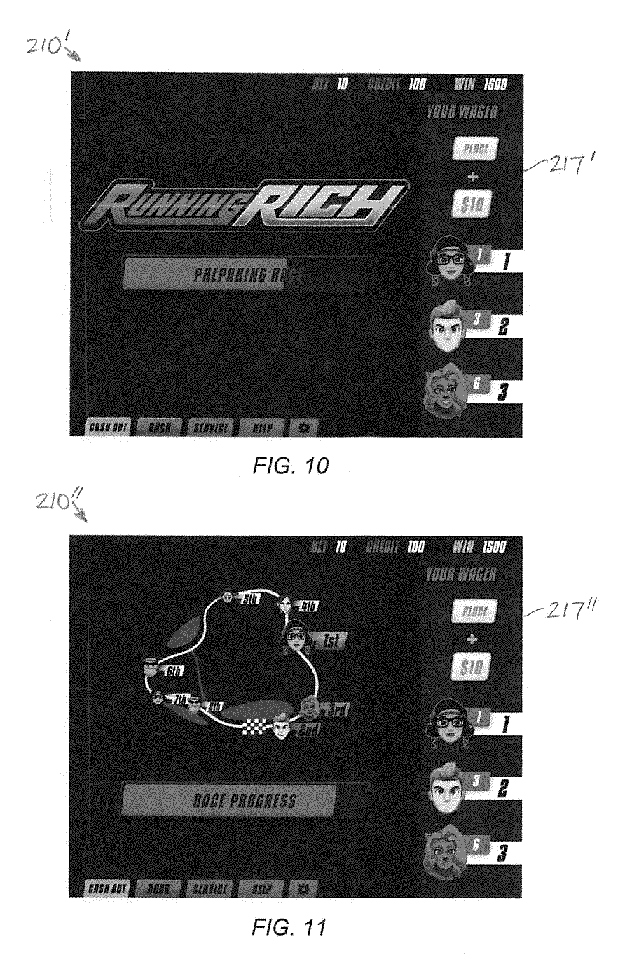

Once the passive participant has completed his or her wager(s), he or she may select the bet button 220 (e.g., touch the location of the display 37 (FIG. 1) of the wagering station 30 (FIG. 1) on which the bet button 220 is located). If a passive participant finalizes, or commits, his or her wager before the designated duration of time for placing side bets expires, an image 210′, such as that shown in FIG. 10 may be provided on the display 37 to indicate how much of the designated duration of time for placing side bets remains. The passive participant's wager may be displayed as part of the image 210′ shown by the display 37 (e.g., along an edge 217′ of the image 210′, etc.).

In embodiments of the game where one or more mystery prizes or bonuses are available to the active participants, the amount of each bonus prize pool may increase as wagers are placed. More specifically, as each wager, including each wager placed by an active participant and/or each side bet, is finalized, a portion of that wager may be contributed to a bonus prize pool. In some embodiments, a fixed percentage of each wager may be contributed to a bonus prize pool. In other embodiments, only a fixed percentage of each side bet will be contributed to a bonus prize pool.

When the designated duration of time for placing side bets has elapsed, game play by the active participants may begin. During game play, progress of the game, including each active participant's progress in the game, may be displayed, as illustrated by FIG. 11. Game progress may be updated throughout the game in real time. The passive participant's wager may continue to be displayed as part of the image 210″ as the game is being played by the active participants.

As the game is being played, one or more mystery prizes or bonuses may be awarded to active participants in the game. A mystery prize or a bonus may comprise a monetary award to its recipient. In a specific embodiment, a game mascot may make one or more so-called “cash drops” during game play (i.e., after the game starts and before the game ends). The timing of a cash drop during an allotted portion of game play may be random. In some embodiments, each cash drop may be made within a predetermined amount of time after the game begins so that it may occur before a character's participation in the game ends (e.g., before the character crosses the finish line in a race game, etc., the timing of which may be based on the active participant's skill at playing the game) so that any animations, celebrations, or the like may occur while that character is still participating in the game.

In some embodiments, the availability of any mystery prize, bonus, or cash drop may be pre-conditioned on the occurrence of a predetermined threshold event. The predetermined threshold event may, in some embodiments, have to occur before game play starts for a corresponding cash drop to be made during game play. As an example of this type of predetermined threshold event, if the value of a bonus prize pool reaches a predetermined threshold before game play begins, a cash drop that corresponds to that bonus prize pool may be made when the game is played.

In other embodiments, the predetermined threshold event may occur during game play, and the corresponding cash drop may be made after the predetermined threshold event has occurred. As an example, a cash drop may be made at any time after a predetermined amount of time has elapsed during game play. In yet another example, one or more active participants may be required to achieve a predetermined threshold event in the game before a cash drop is made available to them (e.g., they have accomplished a predetermined task during game play, progressed to a predetermined location or level in the game, accumulated a predetermined number of points during game play, achieved a predetermined skill level before or during game play, etc.). Alternatively, a cash drop may be available to all active participants in the game.

Each cash drop may be made directly to a randomly selected active participant in the game, or it may be made to a randomly selected location within the game environment, from which it may be claimed by one or more of the active participants in the game. In some embodiments, cash drops may only be made to or claimed by live active participants in the game.

Any mystery prize or bonus received by an active participant in a game may be added to any winnings received by that active participant based on his or her placement in the game. In some embodiments, the value of a mystery prize or bonus may be adjusted based on other factors, such as the active participants performance (e.g., points received, race time, etc.), the active participant's placement upon completing the game, or any other factor. Alternatively, the receipt of a mystery prize or bonus by an active participant in a game may depend, or be conditioned upon, that active participant's performance or placement in the game (e.g., it may only be awarded if the active participant wins the game, places in the game, or shows in the game, etc.).

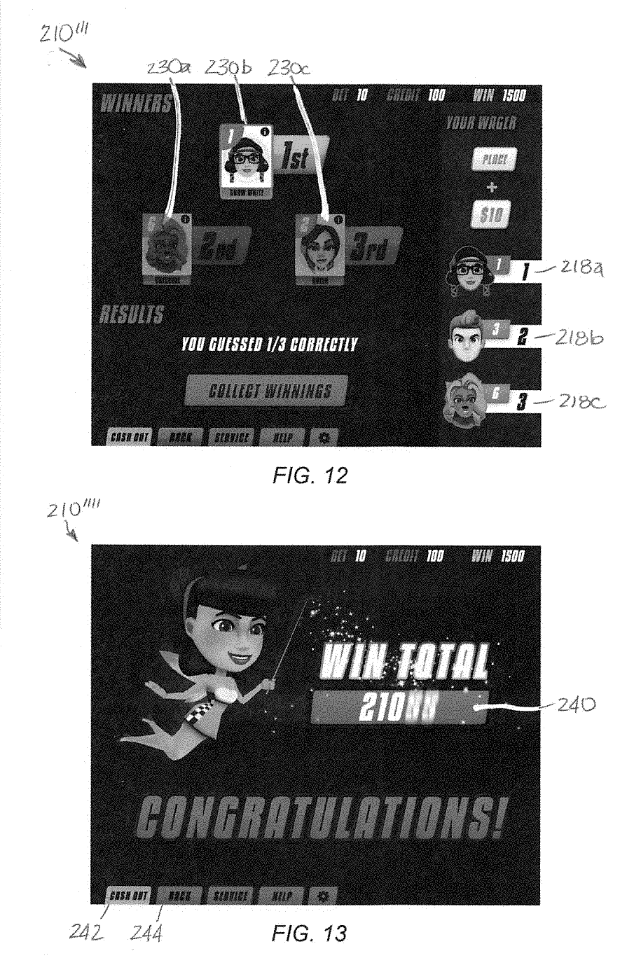

FIG. 12 depicts an image 210′″ that shows the final results of the game. The illustrated image 210′″ shows the characters that correspond to active participants who have taken the top three final placements 230a (first place), 230b (second place), and 230c (third place) in the game. Each final placement 230a, 230b, 230c that corresponds to a winning wager may be highlighted relative to each final placement 230a, 230b, 230c that does not correspond to a winning wager. Similarly, each winning place position 218a, 218b, 218c that was selected by the passive participant while placing his or her wager may be highlighted relative to each losing place position 218a, 218b, 218c. In the illustrated embodiment, Snow White won the race and appears in final placement 230a; Cheshire, who has finished the game in second place, appears in final placement 230b; and Queen, who has finished the game in third place, appears in final placement 230c. Since Snow White was placed at place position 218a as the passive participant's choice to place in the game, and since Snow White actually placed in the game (by winning the game), the representations of Snow White are highlighted at both final placement 230a and place position 218a. Since the passive participant did not select Cheshire or Queen to place in the game, the representations of these characters at final placements 230b and 230c, respectively, are not highlighted on image 210′″. Moreover, since P. Charms was not selected as the passive participant's first choice to place in the game (and/or since P. Charms did not place in the game, depending upon whether or not an embodiment of the game was played in which the passive participant's wager was selectively split or automatically split), the representation of P. Charms at the second place position 218b is not highlighted. Finally, since Cheshire was not picked to place in the game (her character representation was placed in the third place position 218c), her representation at the third place position 218c is not highlighted in the image 210′″ depicted by FIG. 12.

Once the passive participant's total award is calculated, another image 210′″, such as that depicted by FIG. 13, may be shown on the display 37 (FIG. 1) of the wagering station 30 (FIG. 1). That image 210′″ may display the total award 240, or winnings, if any, that the passive participant has received for wagering on the just-concluded game. In addition, the image 210′″ may include a cash out button 242 that may enable the passive participant to receive his or her award (e.g., in cash, as a credit to a monetary account, etc.). The image 210′″ may also include a back button 244 that, when selected, presents the passive participant with an opportunity to wager all or part of his or her award on the next game played at a gaming station 20 (FIG. 1) or a central location 10 (FIG. 1) to which the wagering station 30 corresponds.

Although the foregoing description provides many specifics, these should not be construed as limiting the scope of any of the appended claims, but merely as providing information pertinent to some specific embodiments that may fall within the scope of one or more of the appended claims. Thus, other embodiments may also lie within the scopes of the appended claims. Features from different embodiments may also be employed in combination. All additions to, deletions from, combinations of, and modifications to the disclosed subject matter that fall within the scopes of the claims are to be embraced by the claims.

What is claimed:

1. A gaming method, comprising:
receiving at least one wager on an outcome of a competitive skill-based game at a central location from an active participant in the competitive skill-based game;
receiving at least another wager on an outcome of a competitive skill-based game at the central location from an observer of the competitive skill-based game;
administering play of the competitive skill-based game on at least one gaming station at the central location; and
determining whether a payout should be provided on the at least one wager and/or the at least another wager; and
if a payout should be paid on the at least one wager and/or the at least another wager, paying out on the at least one wager and/or the at least another wager.

2. The gaming method of claim 1, wherein receiving the at least one wager comprises receiving the at least one wager at the at least one gaming station at the central location.

3. The gaming method of claim 1, wherein receiving the at least one wager comprises receiving a plurality of wagers from a plurality of active participants at a plurality of gaming stations at the central location.

4. The gaming method of claim 1, wherein receiving the at least another wager comprises receiving the at least another wager from the observer at a wagering station physically associated with the at least one gaming station at the central location.

5. The gaming method of claim 1, further comprising:
displaying progress of the at least one active participant within the competitive skill-based game from a perspective of a virtual location of the at least one participant within the competitive skill-based game.

6. The gaming method of claim 5, comprising:
individually displaying progress to each active participant of a plurality of active participants within the competitive skill-based game from a perspective of a virtual location of that active participant within an environment of the competitive skill-based game.

7. The gaming method of claim 1, further comprising:
while administering play of the competitive skill-based game, providing a wide area video output of the competitive skill-based game, visible to the observer and to individuals passing by the central location.

8. The gaming method of claim 1, wherein receiving the at least one wager initiates a predetermined period of time for receiving the at least another wager and any additional wagers before administering play of the competitive skill-based game.

9. The gaming method of claim 8, wherein receiving an additional wager from another active participant in the competitive skill-based game re-initiates the predetermined period of time.

10. The gaming method of claim 1, wherein administering play of the competitive skill-based game comprises providing at least one computer-controlled character as competition for the at least one active participant.

11. The gaming method of claim 1, wherein administering play of the competitive skill-based game occurs only with active participants when all available positions at the central location are occupied by active participants who have placed wagers on the competitive skill-based game.

12. The method of claim 1, wherein the competitive skill-based game comprises a game of physical skill.

13. The method of claim 12, wherein the competitive skill-based game comprises a race game.

14. The method of claim 1, further comprising:
measuring a skill level of each active participant during the game.

15. The method of claim 14, wherein measuring the skill level comprises dynamically measuring the skill level of each active participant throughout the game.

16. The method of claim 14, further comprising:
determining the availability of a mystery prize or a bonus to at least one active participant based on a skill level of the at least one active participant immediately before the mystery prize or the bonus is to be provided.

17. The method of claim 14, further comprising:
basing an award to an active participant based on a skill level of the active participant.

18. A gaming method, comprising:
providing a physically competitive game at a central location, the physically competitive game capable of being:
wagered on and played by a plurality of active participants at the central location, each active participant wagering that he or she will win the physically competitive game; and
wagered on by a plurality of passive participants at the central location, each passive participant wagering that a particular competitor in the physically competitive game will achieve a particular outcome in the physically competitive game; and
executing the physically competitive game, in which the at least one active participant competes against at least one other competitor, the act of executing including:
receiving a wager from at least one active participant at the central location; and
initiating game play upon receiving the wager from the at least one active participant;
providing computer-controlled conditions during game play.

19. The gaming method of claim 18, wherein providing the physically competitive game comprises providing a racing game.

20. The gaming method of claim 19, wherein executing the physically competitive game comprises receiving a wager and game inputs at a gaming station at the central location, the gaming station resembling an environment occupied by an actual participant in a type of race simulated by the racing game.

21. The gaming method of claim 20, wherein providing the physically competitive game includes providing at least one wagering station associated with the gaming station at the central location, the at least one wagering station capable of receiving a wager from at least one passive participant.

22. The gaming method of claim 19, further comprising:
providing the at least one active participant with at least one possible bonus award while executing the physically competitive game.

23. The gaming method of claim 18, further comprising:
widely displaying progress of the physically competitive game at the central location to each individual at the central location or passing by the central location.

24. The gaming method of claim 23, wherein widely displaying progress of the physically competitive game at the central location includes providing each individual at the central location or passing by the central location with a spectator's view of the physically competitive game.
